(19) United States
(12) Patent Application Publication
(10) Pub. No.: US 2021/0296841 A1
(43) Pub. Date: Sep. 23, 2021

(54) MULTIMODE WAVE GUIDE CONFIGURED TO GENERATE A SINGLE-MODE RADIATION FROM A SINGLE-MODE RADIATION

(71) Applicants: Compagnie Industrielle des Lasers CILAS, Orléans (FR); Université de Limoges, Limoges (FR); Centre National de la Recherche Scientifique (CNRS), Paris Cedex 16 (FR)

(72) Inventors: Guy MILLOT, Chevannes (FR); Vincent COUDERC, Verneuil-Sur-Vienne (FR); Katarzyna KRUPA, Sulejowek (PL); Alessandro TONELLO, Limoges (FR); Stefan WABNITZ, Roma (IT); Jean-Eucher MONTAGNE, Orleans (FR)

(21) Appl. No.: 17/208,244

(22) Filed: Mar. 22, 2021

(30) Foreign Application Priority Data
Mar. 23, 2020 (FR) 2002799

(51) Int. Cl. H01S 3/067

(52) U.S. Cl. CPC H01S 3/0672; H01S 3/06745

(57) ABSTRACT

A wave guide may have an index profile including at least one maximum. The maximum or maxima of the index profile may correspond respectively to at least one maximum intensity of the outlet radiation with a mode of desired order. The wave guide may also have at least one doping ion configured to absorb the pump radiation. The doping ion or ions may have a concentration profile of doping ions including at least one maximum.

### CROSS-REFERENCE TO RELATED APPLICATIONS

This application claims priority to French Application No. 2002799, filed Mar. 23, 2020, which application is incorporated by reference herein in its entirety.

### TECHNICAL FIELD

The present invention concerns the field of wave guides. In particular, it concerns multimode wave guides, such as multimode optical fibres.

### STATE OF THE ART

Multimode wave guides are not generally used for laser amplifiers. Indeed, multimode wave guides make it possible to simultaneously propagate several transverse modes of a radiation. Thus, a radiation, substantially single-mode at the inlet of a multimode wave guide and propagating itself in the wave guide becomes at the outlet a multimode radiation more divergent than a single-mode radiation. This therefore limits the use of a multimode wave guide in numerous applications, such as biological imaging, LIDAR (“Light Detection And Ranging”), laser designation, spectroscopy, microspectroscopy, etc. The use of a single-mode wave guide seems to be a good solution, in order to minimise the number of outlet modes of the waveguide. However, this type of wave guide is limited regarding the power of the laser radiation which could propagate from it. A multimode wave guide allows a propagation of laser radiations having a greater power than the power possible in a single-mode waveguide. Moreover, the width of a multimode fibre is, generally, greater than the width of a single-mode fibre. This greater width makes it possible to postpone significant parasitic non-linear effects, which preserves the spectral quality of the laser radiation. The propagation of the laser radiations on a reduced number of modes in multimode wave guides is therefore of a great interest to guarantee a laser radiation with good spatial and spectral qualities at the outlet of the waveguide.

### SUMMARY OF THE INVENTION

The present invention aims to overcome the disadvantages of a multimode fibre by proposing a wave guide making it possible to minimise the number of modes which guide radiations up to the outlet of said waveguide.

To this end, the invention concerns a multimode non-linear wave guide configured to generate an outlet radiation substantially single-mode to a mode of desired order from a substantially single-mode inlet radiation in the spatial domain and in the time domain, the inlet radiation being coupled with a pump radiation.

According to the invention, the wave guide has:
an index profile according to a transversal cross-section of the wave guide comprising at least one maximum, the maximum or maxima of the index profile corresponding respectively to at least one maximum of the outlet radiation intensity at the desired order mode;
at least one doping ion configured to absorb the pump radiation, the doping ion or ions having a concentration profile of doping ions according to the transversal cross-section of the wave guide comprising at least one maximum.

Thus, thanks to the waveguide, a periodic index network can be produced by self-imaging and by Kerr effect, which allows an energy exchange between the modes so that the energy from all the modes is transferred to the desired mode.

In addition, the wave guide has a cylindrical core and a peripheral sheath covering the cylindrical core.

In a non-limiting manner, the index profile has a bell-shape.

Advantageously, the index profile has a dissymmetry with respect to a central axis of the waveguide.

For example, the wave guide is wound in order to induce the dissymmetry of the index profile.

According to a particularity, the index profile according to the transversal cross-section responds to the following condition: (n₁²−n₂²)(Rπ/λ₀)²<100,

wherein:
R corresponds to the radius of the cylindrical core,
n₁ corresponds to the maximum index of the cylindrical core,
n₂ corresponds to the index of the peripheral sheath,
λ₀ corresponds to the wavelength of the inlet radiation.

According to another particularity, the wave guide forms an adiabatic tapered optical fibre.

In a non-limiting manner, the concentration profile of doping ions according to the transversal cross-section has a bell-shape.

Advantageously, the concentration of doping ions according to the transversal cross-section has a dissymmetry with respect to the central axis of the waveguide.

The invention also concerns an amplifier system.

According to the invention, the system comprises:
at least one wave guide such as described above,
a radiation source configured to generate a substantially single-mode inlet radiation in the spatial domain and in the time domain;
at least one pump radiation source configured to generate a pump radiation capable of being absorbed by the doping ion or ions,
a coupling device configured to couple the inlet radiation generated by the radiation source and the pump radiation before propagating itself in the waveguide.

According to a particularity, the inlet radiation generated by the radiation source is also a phase-blocked longitudinal mode radiation.

### BRIEF DESCRIPTION OF THE FIGURES

The invention, with its features and advantages, will emerge more clearly upon reading the description made in reference to the appended drawings, wherein:

FIG. 1 represents a cross-sectional view of an embodiment of the amplifier system comprising the waveguide,

FIG. 2 represents an example of an index profile of the waveguide,

FIG. 3 represents periodic images of a periodic network produced by self-imaging,

FIG. 4 represents an index network produced from the period network of FIG. 3, thanks to the Kerr effect.

### DETAILED DESCRIPTION

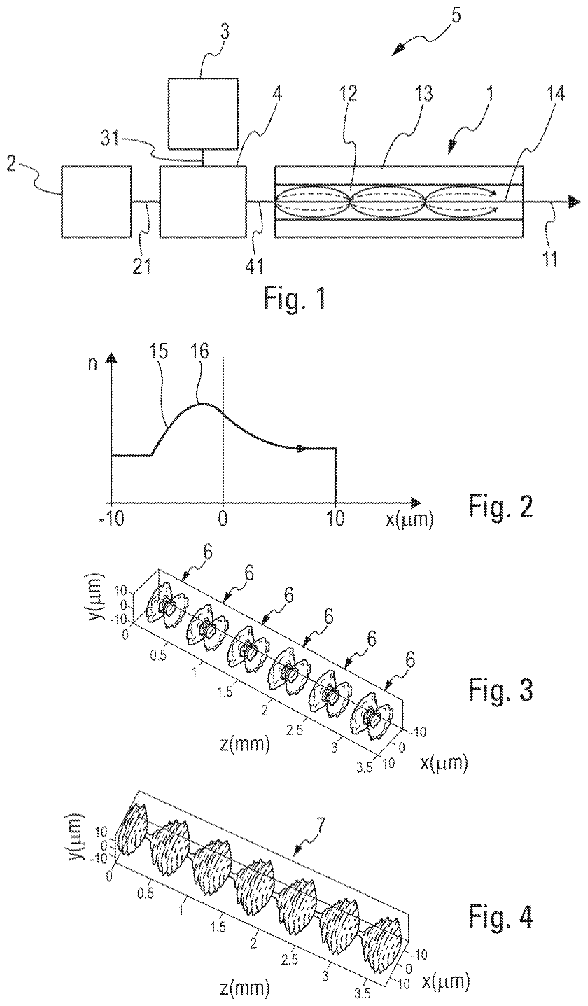

FIG. 1 represents an embodiment of the wave guide 1. Said wave guide 1 is configured to generate an outlet radiation 11 substantially single-mode to a mode of desired order from a substantially single-mode inlet radiation 21 in the spatial domain and in the time domain. The inlet radiation 21 is coupled with a pump radiation 31.

A substantially single-mode radiation corresponds to a radiation having a reduced number of longitudinal and spatial modes. For example, a substantially single-mode radiation has about one to five longitudinal and spatial modes.

According to its transversal cross-section, the wave guide 1 has a (refraction) index profile 15 comprising at least one (index) maximum 16 (FIG. 2). The maximum or maxima 16 of the index profile 15 correspond respectively to at least one maximum intensity of the outlet radiation 11 with the mode of desired order.

The wave guide 1 also has at least one doping ion configured to absorb the pump radiation 31. The doping ion or ions have a concentration profile of doping ions according to the transversal cross-section of the wave guide 1 comprising at least one maximum (of concentration of doping ions).

In a non-limiting manner, the doping ion or ions can correspond to an ytterbium ion or a neodymium (erbium, thulium, etc.).

The multimode wave guide 1 thus configured enables a power transfer of the modes propagating themselves in the wave guide 1 towards a mode of desired order. For example, it enables a power transfer of the modes of higher orders propagating themselves in the wave guide 1 towards one single mode of low order, in particular towards the fundamental mode.

A propagation of the inlet radiation 21 coupled with the pump radiation 31 in the wave guide 1 produces a periodic or quasiperiodic index network 7 for the wavelength of the inlet radiation 21 and for the wavelength of the pump radiation 31. The periodic index network 7 comes from self-imaging (or “Talbot” effect) and the Kerr effect.

Self-imaging makes it possible to periodically obtain an image 6 of the incident radiation 41 at the inlet of the wave guide 1 at the end of a specific length of the wave guide 1. The specific length corresponds to a length for which all the inlet modes of the wave guide 1 are found in their same relative phase state. FIG. 3 represents the places in the wave guide 1 where the inlet modes of the wave guide 1 are located with their same relative phase state. Thus, an image 6 of the incident radiation 41 is periodically reproduced in the wave guide in the propagation direction of radiation. Self-imaging thus makes it possible to produce a periodic or aperiodic network. The network is periodic or aperiodic depending on the profile of the wave guide 1 being stable or evolving in diameter.

The Kerr effect makes it possible to modulate the index of the wave guide 1 by a radiation propagating itself in said wave guide 1. The Kerr effect thus transforms the period or aperiodic network, produced by self-imaging, into a periodic or aperiodic index network 7. FIG. 4 represents the periodic or aperiodic index network 7 obtained from the periodic or aperiodic network of FIG. 3.

The Raman effect can also be at the origin of the modification of the index network 7 due to its preferably high gain at the level of the nodes of the network.

The periodic or aperiodic index network 7 allows to favour the four-wave mixing and therefore to break the orthogonality between the modes and to allow an energy exchange between them. For a high inlet radiation power 21, the energy previously distributed over a set of modes is transferred towards a mode of desired order, in particular towards the fundamental mode, which corresponds to a spatial cleaning of the outlet radiation 11.

According to an embodiment, the wave guide 1 has a cylindrical core 12 and a peripheral sheath 13 covering the cylindrical core 12.

According to other embodiments, the wave guide can take other shapes, such as a shape of which the transversal cross-section is square, oval, etc.

Advantageously, the cylindrical core 12 is crystalline.

In a non-limiting manner, the cylindrical core can be manufactured from an ytterbium-aluminium garnet doped with neodymium or from a crystal doped with ytterbium.

In a non-limiting manner, the index profile 15 has a bell-shape. The bell-shape can correspond to a triangular shape, a Gaussian shape, a super-Gaussian shape, a Lorentz shape, a pseudo-parabolic shape, etc.

Moreover, the index profile 15 according to the transversal cross-section has a dissymmetry with respect to the central axis 14 of the wave guide 1, as represented in FIG. 2. The central axis 14 corresponds to a longitudinal axis of the wave guide 1 situated at the centre of the wave guide 1.

The dissymmetry of the index profile 15 can be induced by a winding of the wave guide 1.

Preferably, the index profile 15 according to the transversal cross-section of the wave guide 1 responds to the following condition:

$$( {n}_{1}^{2} - {n}_{2}^{2} ) {( \frac{R π}{{λ}_{0}} )}^{2} \leq 100$$

wherein:
R corresponds to the radius of the cylindrical core,
n₁ corresponds to the maximum index of the core,
n₂ corresponds to the index of the peripheral sheath,
λ₀ corresponds to the wavelength of the inlet radiation.

This condition makes it possible to obtain a wave guide 1 having a number of modes substantially less than one hundred modes.

The wave guide 1 can form an adiabatic tapered optical fibre. This form of wave guide 1 allows for an evolution (such as an improvement) in self-imaging and in the Kerr effect.

Moreover, the concentration profile of doping ions according to the transversal cross-section has a bell-shape. In the same way as for the index profile 15, the bell-shape can correspond to a triangular shape, a Gaussian shape, a super-Gaussian shape, a Lorentz shape, a pseudo-parabolic shape, etc.

Likewise, the concentration of doping ions according to the transversal cross-section can have a dissymmetry with respect to the central axis 14 of the wave guide 1.

The invention also concerns an amplifier system 5.

The amplifier system 5 comprises at least one wave guide 1.

The amplifier system 5 also comprises at least one radiation source 2 configured to generate the substantially single-mode inlet radiation 21 in the spatial domain and in the time domain. The radiation source 2 can be a temporally non-symmetrical pulse source.

For example, the radiation source 2 can comprise an Nd:YAG laser producing an outlet radiation 21 with a wavelength of 1064 nm and with a pulse of 60 ps.

The inlet radiation 21 generated by the radiation source 2 can be a phase-blocked longitudinal mode radiation.

The amplifier system 5 further comprises at least one pump radiation source 3 configured to generate the pump radiation 31, capable of being absorbed by the doping ion or ions. The pump radiation source 3 can correspond to a power diode. The pump radiation source 3 can operate in a pulsed or continuous regime. It can be fibred, or non-fibred. It can be spatially multimode or single-mode.

The amplifier system 5 also comprises a coupling device 4 configured to couple the inlet radiation 21 generated by the radiation source 2 and the pump radiation 31 before propagating in the wave guide 1.

The coupling device 4 can comprise an insulator, a coupling lens, a spatial light modulator to control the wave (radiation) in phase and in amplitude which is propagated in the wave guide 1 (fibre), a wave plate (λ/2 and/or λ/4) to rotate or decompose the polarisation. The wave plate, the position of the coupling lens and/or the spatial light modulator make it possible to choose the mode of desired order.

The coupling device 4 can excite the modes with a spatially divergent radiation.

Advantageously, the coupling device 4 can be fibred, or solid. It can comprise a spectral filter and/or a spatial filter to improve the pump radiation 31. It can be with parabolic multimode fibres or with single-mode fibres.

The system 5 can be used as a laser source by adding two partially reflective mirrors disposed respectively at an end of the wave guide 1 (not represented).

The system can comprise several wave guides 1, coupled or not.

The spatial cleaning of the outlet radiation 11 makes it possible to keep a coherence between several parallel amplifications produced in two different wave guides 1.

1. A non-linear multimode wave guide configured to generate a substantially single-mode outlet radiation with a mode of desired order from a substantially single-mode inlet radiation in the spatial domain and in the time domain, the inlet radiation being coupled with a pump radiation, wherein the wave guide has:
an index profile according to a transversal cross-section of the wave guide comprising at least one maximum, the maximum or maxima of the index profile corresponding respectively to at least one maximum intensity of the outlet radiation with the mode of desired order;
at least one doping ion configured to absorb the pump radiation, the doping ion or ions having a concentration profile of doping ions according to the transversal cross-section of the wave guide comprising at least one maximum.

2. The wave guide according to claim 1, wherein the wave guide has a cylindrical core and a peripheral sheath covering the cylindrical core.

3. The wave guide according to claim 1,
wherein the index profile has a bell-shape.

4. The wave guide according to claim 1,
wherein the index profile has a dissymmetry with respect to a central axis of the wave guide.

5. The wave guide according to claim 1,
wherein the wave guide is wound in order to induce the dissymmetry of the index profile.

6. The wave guide according claim 1,
wherein the index profile according to the transversal cross-section responds to the following condition:
$$( {n}_{1}^{2} - {n}_{2}^{2} ) {( \frac{R π}{{λ}_{0}} )}^{2} \leq 100 ,$$
wherein:
R corresponds to the radius of the cylindrical core,
n₁ corresponds to the maximum index of the cylindrical core,
n₂ corresponds to the index of the peripheral sheath,
λ₀ corresponds to the wavelength of the inlet radiation.

7. The wave guide according to claim 1,
wherein the wave guide forms an adiabatic tapered optical fiber.

8. The wave guide according to claim 1,
wherein the concentration profile of doping ions according to the transversal cross-section has a bell-shape.

9. The wave guide according to claim 1,
wherein the concentration of doping ions according to the transversal cross-section has a dissymmetry with respect to the central axis of the wave guide.

10. An amplifier system comprising:
at least one wave guide according claim 1,
a radiation source configured to generate a substantially single-mode inlet radiation in the spatial domain and in the time domain;
at least one pump radiation configured to generate a pump radiation capable of being absorbed by the doping ion or ions,
a coupling device configured to couple the inlet radiation generated by the radiation source and the pump radiation before propagating itself in the wave guide.

11. The system according to claim 10,
wherein the inlet radiation generated by the radiation source is also a phase-blocked longitudinal mode radiation.
